(19) United States
(12) Patent Application Publication
(10) Pub. No.: US 2005/0084135 A1
(43) Pub. Date: Apr. 21, 2005

(54) Method and system for estimating displacement in a pair of images

(76) Inventor: Mei Chen, Stanford, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/687,715

(22) Filed: Oct. 17, 2003

(51) Int. Cl. G06K 9/00; H04N 5/14

(52) U.S. Cl. 382/107; 348/699

(57) ABSTRACT

A method, system and apparatus for estimation of apparent displacement of an object between two images incorporates multiple hypotheses. Search range and step size are selected for testing a plurality of hypotheses. An estimate of object motion is made on a per hypothesis basis and the validity of each of such estimates is measured. Validity measurements that exceed the cutoff value are compared and the estimate of motion having the highest measure of validity is chosen as the most likely apparent displacement of the object.

### BACKGROUND

1. Field of the Invention

The present invention relates to methods and systems for estimating apparent frame-to-frame image displacement. More particularly, this invention pertains to such a method, and a related system, that employs the testing of multiple hypotheses.

2. Description of the Prior Art

Registration between two images (i.e., determination of the apparent displacement of the location of an object, comprising a portion of an image, fixed in two different image frames) is central to applications based upon image correspondence. Such applications include, for example, three-dimensional stereo analysis, video enhancement, mosaicing and object tracking.

Most images involve the capture of “real” or three-dimensional objects onto a two dimensional medium. As such, the third dimension, representing depth, is not taken into account. In stereo imaging, in which the reference and target images are taken through two lens systems of known focal length(s) and separation, depth measurement is often a central objective. Depth measurement through stereo imaging has many significant medical applications (e.g. endoscopy).

It has been found that accurate image registration is complicated when the degree of apparent displacement becomes significant, due, for example, to large in-scene object motion (common in the case of sporting events), or large depth change in three-dimension such as that accompanying large camera zoom motion. Generally, prior art attempts at image registration have relied upon multi-resolution techniques such as image pyramids.

While effective for image registration in the presence of moderate amounts of image motion, multiresolution approaches are insufficient in the presence of large image motion. For example, when an image of 640×480 pixels is down-sampled to 20×15 pixels as a result of a power of five reduction (i.e. one pixel of the pyramided image represents an area of 32×32 (2⁵×2⁵) pixels of the “original” image). As a consequence, sub-pixel motion estimation accuracy cannot be achieved for a displacement greater than 32 pixels of the “original” image. Unfortunately, significant image motion is not uncommon in sports videos or other videos having very dynamic scenes.

### SUMMARY OF THE INVENTION

The present invention addresses the foregoing and other shortcomings of the prior art by providing, in a first aspect, a method for estimating the displacement of at least one object with respect to a first image and a second image. Such object is fixed within each of the first and second images.

The method is begun by generating a plurality of search regions within the second image based on selected search parameters. An estimate of object displacement is determined for each of the search regions and the validity of each of such estimates is measured. The measurements of validity are compared and the best object estimate determined. Such best estimate corresponds to the displacement of the object.

In a second aspect, the invention provides a system for estimating the displacement of at least one object with respect to a first image and a second image, wherein the object is fixed within each of the first image and the second image.

Such system includes a search region generator that is adapted to receive the first and second images, as well as selected search parameters, as inputs and to provide a plurality of search regions in response. An object displacement estimator is adapted to receive the plurality of search regions and to provide a plurality of object displacement estimates in response. A validity measurer is adapted to receive the plurality of object displacement estimates and to provide a plurality of validity measurements in response. Finally, a validity comparator is adapted to receive the plurality of validity measurements and to provide a best object displacement estimate in response.

In a third aspect, the invention provides apparatus for estimating the displacement of at least one object with respect to a first image and a second image in which the object is fixed within each of the first image and the second image. Such apparatus includes means for generating a plurality of search regions within said second image based on selected search parameters.

Means are provided for determining an object displacement estimate for each of the search regions and for measuring the validity of each of the plurality of estimated object displacements. Means are further provided for comparing the validity measurement to determine a best object displacement estimate.

The preceding and other features of the invention will become further apparent from the detailed description that follows. Such description is accompanied by a set of drawing figures. Numerals of the drawing figures, corresponding to those of the written description, point to the features of the invention. Like numerals refer to like features throughout both the written description and the drawing figures.

### BRIEF DESCRIPTION OF THE DRAWINGS

FIG. 1 is a representation of the apparent displacement of an object fixed in an image pair;

FIG. 2 is a flow chart of an embodiment of a method in accordance with the invention for estimating object displacement in an image pair;

FIG. 3 is a representation of operations performed according to one embodiment of a method of the invention; and

FIG. 4 is a block diagram of an embodiment of a system in accordance with the invention for estimating object displacement in an image pair.

### DETAILED DESCRIPTION OF THE PREFERRED EMBODIMENT

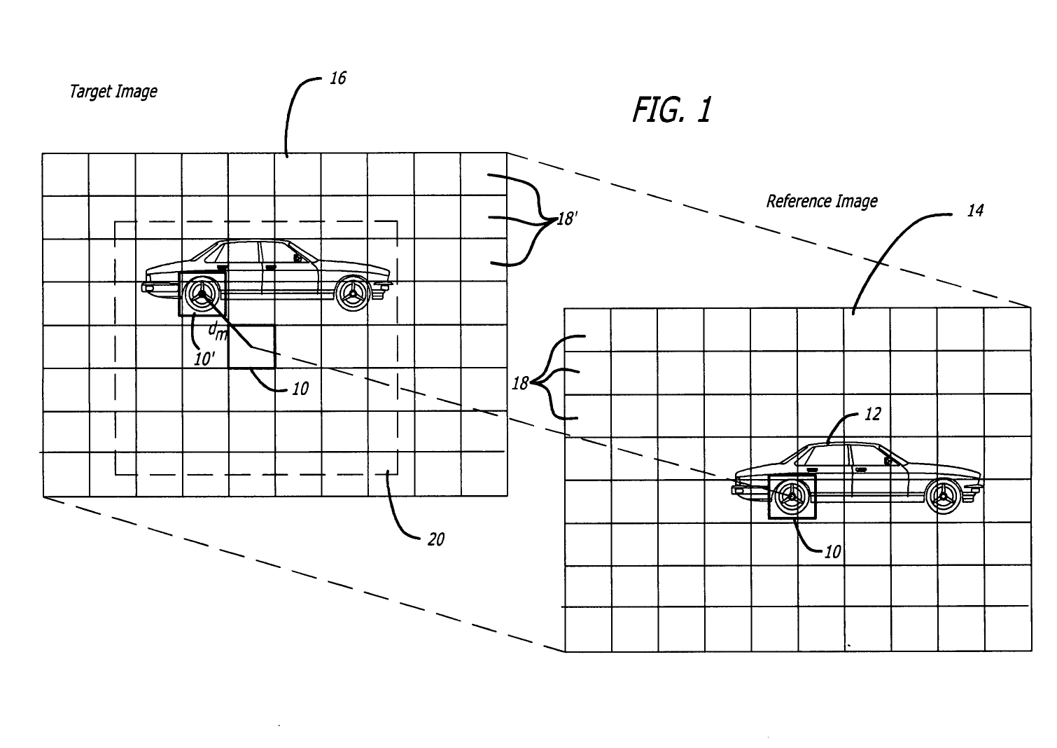

FIG. 1 is a representation of the displacement of an object fixed in an image pair and, thus, illustrates the problem addressed by the method of the invention. Briefly, motion estimation involves determination of the apparent displacement of an object 10, such as the rear wheel of an automobile 12, between views fixed in a first or reference image 14 and a second or target image 16. Each of the images 14 and 16 is either digital or digitized and defined over a pixel matrix that may be broken up, for convenience of illustration, into a plurality of blocks of two-dimensional pixel arrays 18, 18′.

Analysis of displacement of the object 10 between the two images 14 and 16 essentially involves the determination of a vector dₘ defining magnitude and direction on a two-dimensional image field. The vector dₘ is located within a search region 20 and relates the location of the object 10 in the first or reference frame 14 to that of the object in the second or target frame 16.

As is implied by the statement of the problem as illustrated in FIG. 1, the vector dₘ is located within a search region 20 and, thus, determination of dₘ is related to the definition of the search region 20. In general, the larger the area of the search region 20, the greater the probability of finding the displaced object. However, a very large search area is neither optimal nor efficient because it is prone to local optima and computational burden is directly related to the size of the search area.

The definition of an appropriate search area is thus desirable for any effective method for measuring object displacement. Unfortunately, this becomes quite difficult when there exists a large degree of object displacement, as in the case of sporting events. In such cases, determination of a search area of reasonable size that contains the object is difficult.

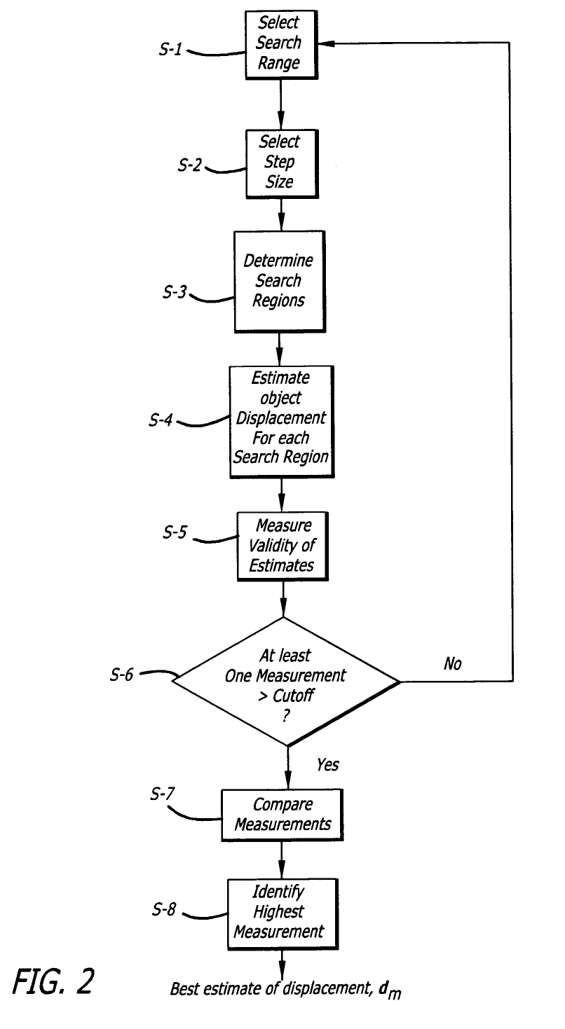

FIG. 2 is a flow chart of one embodiment of a method of the invention for estimating the displacement of an object fixed in a pair of related images. (Note: The flow chart of FIG. 2 assumes search regions of a given uniform size and a motion model of known trajectory.) The method of the invention overcomes difficulties associated with the selection of an appropriate search region by utilizing a multiple hypothesis and testing approach in which each of a plurality of search regions corresponds to a hypothesis regarding the correct region of object displacement. Such process is begun at step S-1 by making an initial or rough estimate by selecting an expected search range of displacement of the object between the first and second images. Such an estimate may include “x” and “y” components to define the entire range to be covered by the search regions of a plurality of hypotheses.

A step size is selected at S-2. The step size measures the incremental advance between the search regions of consecutive hypotheses in traversing the search range. Since hypotheses may cover a two-dimensional field, step sizes may be two dimensional vectors comprising x and y components. (In the case of an underlying motion model that assumes pure one-dimensional translational displacement, one-dimensional steps are employed.)

In one embodiment, the selections of step size and search regions can be related to one another. In this case step sizes can be chosen that assure overlapping areas of sequential search regions along a path determined by a preselected motion model. As a result, a search region may include the entire object, a portion of the object or none of the object. This may optimize the eventual determination of the most likely hypothesis (i.e. the search region that is most likely to include the object).

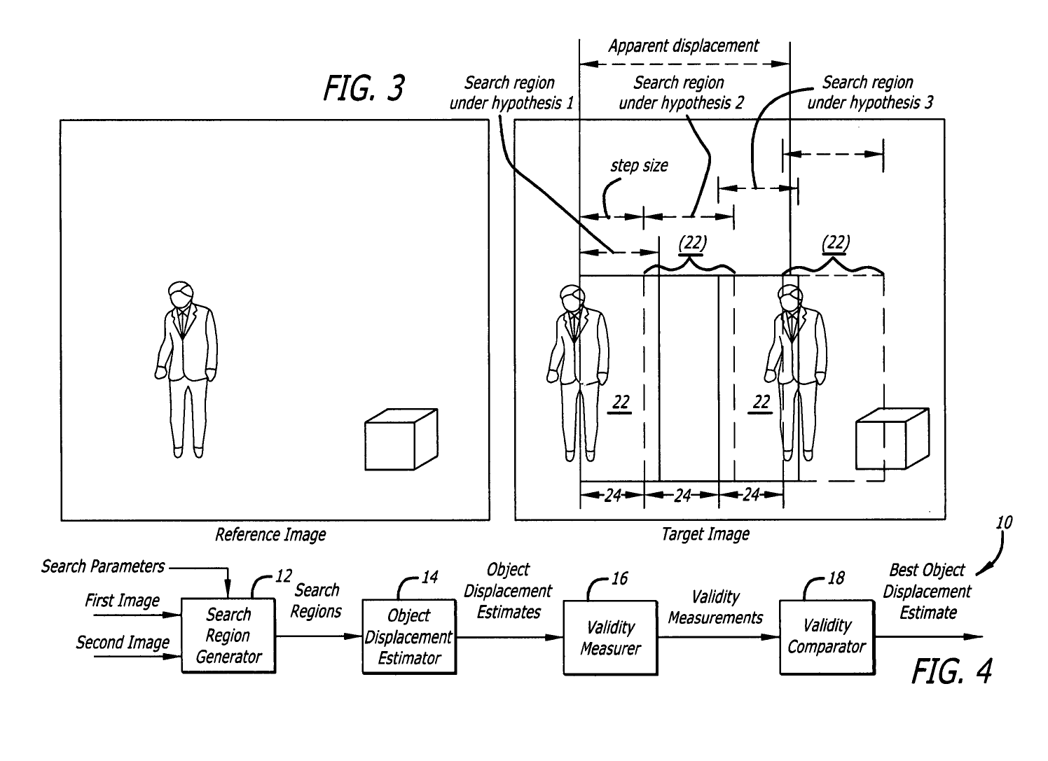

Returning to the flow chart of FIG. 2, a set of search regions is determined on the basis of selected search parameters. Such search parameters necessarily include search range and step size, as illustrated in FIG. 2, but may also include such other parameters as motion model trajectory and search region size or dimensions. FIG. 3 is a representation of the sequential process for advancing from hypothesis to hypothesis in accordance with a chosen motion model, search regions 22 and step size 24. For clarity of illustration, FIG. 3 is based upon a pure horizontal translation motion model. As mentioned above, it can be noted that, due to the relative sizes of the search regions 22 and the linking steps 24, areas of adjacent search regions 22 overlap.

While a plurality of search regions 22 may be examined that lie along the trajectory defined by a preselected motion model, the pixel-wise dimensions of a search region are preferentially selected to assure that the associated analysis of the multiple search regions is considerably less than that involved in searching the entire image.

In prior processes, a single search region is chosen and examined for a preselected motion model and that region is assumed to contain the object. As a result, such processes are vulnerable to the possibility of misinterpretation of a “current best estimate” as the eventual best estimate of image motion. In contrast, in the present invention, a plurality of search regions lying along the path or trajectory defined by a preselected motion model are each measured, the measurements screened for plausibility, then plausible results compared to determine the best result. This reduces the possibility of wrongful determination of object displacement resulting from error in selection of the search region.

An estimation of object displacement (dₘ) is made for each of the candidate hypotheses (search regions) at step S-4. Any of a number of processes, well known to those skilled in the art and including but not limited to multi-resolution approaches, optical flow and the like, may be employed to obtain such estimations. Such processes result in examination of the most promising area within a search region (i.e. the area possessing characteristics (e.g. texture, luminance, color) most similar to that of the object. Each such examination of a search region yields a dₘ estimate that is the best estimate of the amount of displacement between the object in the target and reference images assuming that the object in the target image is within the candidate search region. Algorithms and related information for performing object displacement estimation as above-described are known and understood by those skilled in the art.

After a candidate dₘ (estimate of displacement) is determined for each candidate hypothesis (search region under examination) of the target image, the validity of each of such estimates over the chosen range is measured at step S-5. Numerous processes, well known to those skilled in the art, exist for measuring the validity of a candidate estimate of object displacement dₘ between two images. Such methods include, for example, image reconstruction (“warping”) and correlation as well as residual error analysis.

A cutoff value for measurements of validity follows from the particular analytical method employed for measuring the validity of the dₘ estimates. Such cutoff value, which may be either statistically-based or quasi-arbitrary, represents and establishes a “floor” beneath which the dₘ of a given candidate search region has insufficient measured validity to permit that region (or its associated dₘ) to be considered further in the determination of object displacement.

At step S-6 the measurements of validity of dₘ estimates are compared to the cutoff value. In the event that none of the validity measurements is found to exceed the cutoff value, all estimates are rejected and the method returns to step S-1. The preceding steps S-1 through S-6 are then repeated on the basis of a new search range. The selection of a new search range may involve extension of the range previously investigated in accordance with the motion model upon which the previously-investigated range was based.

Alternatively, other search parameters may be adjusted. In other embodiments of a method in accordance with invention, one or more of such search parameters as step size, motion model trajectory or search region dimension might be revised in lieu of or in addition to selection of a new search range.

Assuming that the measurement of validity for at least one of the regions or hypotheses is found to exceed the cutoff value at step S-6 on the basis of a set of search parameters, the method of the invention proceeds to step S-7 where a comparison is made of all validity measurements found to exceed the cutoff value. At step S-8, a hypothesis or search region is designated and chosen as the most likely on the basis of the comparison of validity measurements. The value of dₘ associated with the chosen search region is determined as the best estimate of displacement or the best candidate for further fine-tuning of the displacement in accordance with the invention.

FIG. 4 is a block diagram of an embodiment of a system 10 in accordance with the invention for estimating object displacement in image pairs. The system includes a search region generator 12. Such apparatus is arranged to perform functions discussed particularly with reference to steps S-1 through S-3 of the method outlined in the preceding figures.

The search region generator 12 receives, as inputs, the first image and the second image as well as the above-described search parameters. These are employed to generate a plurality of search regions. Such search regions are applied to an object displacement estimator 14. Such apparatus is arranged to perform, in particular, the function described with reference to step S-4 of the method of the preceding figures.

The output of the object displacement estimator 14, a corresponding plurality of object displacement estimates, is applied to a validity measurer 16. Referring to the preceding figures and accompanying discussion, the validity measurer 16 comprises apparatus arranged to perform the function particularly described with reference to step S-5 of the method outlined in FIG. 2. That is, the measurer 16 provides a plurality of validity measurements, corresponding to a plurality of object displacement estimates, that are then provided, as inputs, to a validity comparator 18. The comparator 18 is arranged to make a determination of the best object displacement estimate in accordance with steps S-6 and S-7 of the method described above. In the event that none of the plurality of validity measurements exceeds a predetermined cutoff value, a new set of search parameters is input to the search region generator 12 and, after subsequent data processing by the object displacement estimator 14 and the validity measurer 16, a new plurality of validity measurements is input to the validity comparator 18. Assuming that at least one of the new plurality of validity measurements now exceeds the predetermined cutoff value, a best object displacement estimate is determined by the validity comparator 18 and provided as the displacement of the object between the first and second images.

As mentioned earlier, the method of the invention differs from prior art techniques that rely upon a single search region within a preselected motion model. Such techniques are subject to the detection of local optima. By systematically examining a number of related search regions and selecting the most valid estimate, a number of safeguards are built into the method of the invention. By examining a number of search regions related to one another by a motion model, the possibility of a local optimum is minimized since it is less likely that one's rough motion range assumption will miss the object. By measuring the validity of each candidate search region, one has a measure of confidence that the chosen estimate of object displacement is not implausible as the method of the invention directs one to examine new search ranges until plausible results are available for evaluation of a best result.

While this invention has been disclosed with reference to its presently-preferred embodiment, it is not limited thereto. Rather, the invention is limited only insofar as it is defined by the following set of patent claims and includes within its scope all equivalents thereof.

1. A method for estimating the displacement of at least one object with respect to a first image and a second image, wherein the object is fixed within each of the first image and the second image, the method comprising:
generating a plurality of search regions within said second image based on a plurality of search parameters;
determining an object displacement estimate for each of the search regions;
measuring the validity of each of the plurality of estimated object displacements;
comparing the validity measurements to determine the best object displacement estimate;
wherein the best object displacement estimate corresponds to the displacement of the object.

2. A method as defined in claim 1 wherein the search parameters are selected from the group that consists of search region dimensions, motion model trajectory, search range and step size.

3. A method as defined in claim 2 wherein generating a plurality of search regions comprises:
selecting a range of displacement of the object;
selecting step size for traversing the range within the second image; and
determining a plurality of search regions within the second image based upon step size and selected range of displacement.

4. A method as defined in claim 2 further including:
comparing each of said measurements of validity to a cutoff value;
selecting at least one new search parameter in the event that none of the measurements of validity exceeds the cutoff value;
determining apparent displacement in accordance with the at least one new parameter.

5. A method as defined in claim 1 wherein the search regions are related to one another.

6. A method as defined in claim 5 wherein the search regions are related to one another by a preselected motion model.

7. A method as defined in claim 2 wherein the number of search regions is related to step size.

8. A method as defined in claim 1 wherein adjacent search regions include overlapping areas.

9. A method as defined in claim 1 wherein determining an object displacement estimate further comprises performing a multiresolution analysis.

10. A method as defined in claim 1 wherein determining an object displacement estimate further comprises performing an optical flow analysis.

11. A method as defined in claim 1 wherein measuring validity further comprises performing an image reconstruction and correlation analysis.

12. A method as defined in claim 1 wherein measuring validity further comprises performing a residual error analysis.

13. A system for estimating the displacement of at least one object with respect to a first image and a second image, wherein the object is fixed within each of the first image and the second image, the system comprising, in combination:
a) a search region generator adapted to receive the first and second images and selected search parameters as inputs and to provide a plurality of search regions in response;
b) an object displacement estimator adapted to receive the plurality of search regions and to provide a plurality of object displacement estimates in response;
c) a validity measurer adapted to receive the plurality of object displacement estimates and to provide a plurality of validity measurements in response; and
d) a validity comparator adapted to receive the plurality of validity measurements and to provide a best object displacement estimate in response.

14. A system as defined in claim 13 wherein:
a) the search parameters include search range and step size; and
b) the search region generator is arranged to determine the plurality of search regions within the second image based upon the step size and the selected range of displacement.

15. A system as defined in claim 13 wherein the validity comparator is arranged to compare each of the validity measurements to a predetermined cutoff value.

16. A system as defined in claim 15 wherein the validity comparator is arranged to determine the best validity measurement that exceeds the predetermined cutoff value.

17. Apparatus for estimating the displacement of at least one object with respect to a first image and a second image, wherein the object is fixed within each of the first image and the second image comprising, in combination:
a) means for generating a plurality of search regions within the second image based on selected search parameters;
b) means for determining an object displacement estimate for each of the search regions;
c) means for measuring the validity of each of the plurality of estimated object displacements;
d) means for comparing the validity measurement to determine a best object displacement estimate.
